(19) United States
(12) Patent Application Publication
(10) Pub. No.: US 2003/0218384 A1
(43) Pub. Date: Nov. 27, 2003

(54) Electronic apparatus and power control method

(75) Inventor: Kiyokazu Yoneda, Minato-ku (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/442,599

(22) Filed: May 20, 2003

(30) Foreign Application Priority Data
May 22, 2002 (JP) 2002-147918

(51) Int. Cl. H02J 1/10; H02J 3/06; H02J 3/38; H02J 7/34

(52) U.S. Cl. 307/19

(57) ABSTRACT

A DC/DC converter operation control circuit determines whether or not a signal outputted from a CPU corresponds to a low power consumption mode. If the signal shows the low power consumption mode, the DC/DC converter operation control circuit outputs a signal representing an intermittent or stop operation so that the operation of a DC/DC converter can be operated in an intermittent mode or stopped. On the other hand, if the signal outputted from a CPU shows a normal mode, the DC/DC converter operation control circuit outputs a signal representing a continuous mode or a start operation to supply additional power.

### CROSS-REFERENCE TO RELATED APPLICATIONS

This application is based upon and claims the benefit of priority from the prior Japanese Patent Application No. 2002-147918, filed May 22, 2002, the entire contents of which are incorporated herein by reference.

### BACKGROUND OF THE INVENTION

1. Field of the Invention

The present invention relates to an electronic apparatus such as a notebook computer, and to a power control method of the same apparatus. In particular, the present invention relates to an electronic apparatus, which can improve efficiency in low power consumption under the condition that load fluctuation is very large, and to a power control method of the same apparatus.

2. Description of the Related Art

In recent years, various kinds of computers such as a desktop or notebook type, what is called, personal computers have been produced and put on the market. The processing capability of a CPU functioning as the principal part of this kind of personal computers is continuing to rapidly improve. With such rapid improvement, power consumption ever increases. Recently, in order to accommodate such increase of power consumption, use has been made of a DC/DC converter for the CPU power in an arrangement that several DC/DC converters are connected in parallel.

The power consumption of the above CPU is very small in the standbystate. For this reason, if several parallel connected DC/DC converters are used, the available efficiency dramatically decreases. As a result, for example, if two DC/DC converters are used, it is desirable to stop operation of one of them in the standby state.

Detecting a primary current has so far been used to control the start/stop operation of the DC/DC converter. For instance, if the shift from the stopped state to the start operation state is made, when a load current increases, the primary current also increases. For this reason, a converter control section determines whether parallel or single DC/DC operation is suitable, and thereby, the control of the start/stop is just barely able to be carried out. Thus, the following condition is required. The load current is set so as not to exceed a current capable of being supplied by a single DC/DC converter while the parallel operation is started after the load current starts to increase.

However, The current consumption of the CPU fluctuates very rapidly. For this reason, even if the shift to the parallel operation is made after the increase of the current is detected, the power supply to the CPU is not enough. As a result, there is a problem that a voltage drop takes place. Conversely, if the load becomes low rapidly, there is a problem that the voltage rapidly increases.

In addition, a range of the load fluctuation of the CPU is very wide, and in the low power consumption mode, the current consumption is very small with respect to the supply capability of one DC/DC converter. For this reason, even if one of two DC/DC converters is stopped, there is a problem that efficiency is not sufficiently improved.

### BRIEF SUMMARY OF THE INVENTION

An embodiment of the present invention may provide an electronic apparatuses, which can improve efficiency in low power consumption under the condition that load fluctuations are very large, and to a power control method of the same.

According to an aspect of the present invention, an electronic apparatus is operable in a first mode operating at a first power and a second mode operating at a second power smaller than the first power, comprising: a first power supply unit configured to supply power to the electronic apparatus when the electronic apparatus operates in the first or second mode; and a second power supply unit configured to supply power to the electronic apparatus in the first mode, and stop the power supply to the electronic apparatus in the second mode.

The another aspect of the present invention also provides an electronic apparatus operable in a first mode operating at a first power and a second mode operating at a second power smaller than the first power, comprising: a first power supply unit configured to supply power to the electronic apparatus; a second power supply unit configured to supply power to the electronic apparatus; and a control unit configured to stop an operation of the second power supply unit when the electronic apparatus shifts from the first mode to the second mode.

The another aspect of the present invention also provides an electronic apparatus operable in a first mode operating at a first power and a second mode operating at a second power smaller than the first power, comprising: a first power supply unit configured to supply power to devices included in the electronic apparatus; a second power supply unit configured to supply power to devices included in the electronic apparatus; and a control unit configured to operate the first and second power supply unit when the electronic apparatus operates in the first mode, and stop the operation of the second power supply unit when the electronic apparatus operates in the second mode.

The another aspect of the present invention also provides an electronic apparatus operable in a first mode operating at a first power and a second mode operating at a second power smaller than the first power, comprising: at least two or more power supply units; and a control unit configured to shift the operation of the power supply unit from a continuous power supply mode to an intermittent power supply mode when the electronic apparatus shifts from the first mode to the second mode.

The another aspect of the present invention also provides a power control method of an electronic apparatus including first and second power supply units and operable in a first mode operating at a first power and a second mode operating at a second power smaller than the first power, comprising: stopping the operation of the second power supply unit when the electronic apparatus shifts from the first mode to the second mode.

The another aspect of the present invention also provides a power control method of an electronic apparatus including at least two or more power supply units and operable in a first mode operating at a first power and a second mode operating at a second power smaller than the first power, comprising: shifting the operation of the power supply units from a continuous power supply mode to an intermittent power supply mode when the electronic apparatus shifts from the first mode to the second mode.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a DC/DC converter section applied to an electronic apparatus according to a first embodiment of the present invention;

FIG. 2 is a block diagram showing the configuration of an electronic apparatus according to the first embodiment;

FIG. 3 is a flowchart showing a power control according to the first embodiment;

FIG. 4 is a block diagram showing the configuration of a DC/DC converter section applied to an electronic apparatus according to a second embodiment of the present invention;

FIG. 5 is a block diagram showing the configuration of an electronic apparatus according to the second embodiment;

FIG. 6 is a flowchart showing a power control according to the second embodiment;

FIG. 7 is a block diagram showing the configuration of a DC/DC converter section applied to an electronic apparatus according to a third embodiment of the present invention;

FIG. 8 a block diagram showing the configuration of an electronic apparatus according to the third embodiment; and

FIG. 9 is a flowchart showing a power control according to the third embodiment.

### DETAILED DESCRIPTION OF THE INVENTION

The embodiments of the present invention will be described below with reference to the drawings.

### First Embodiment

The first embodiment the present invention will be described below.

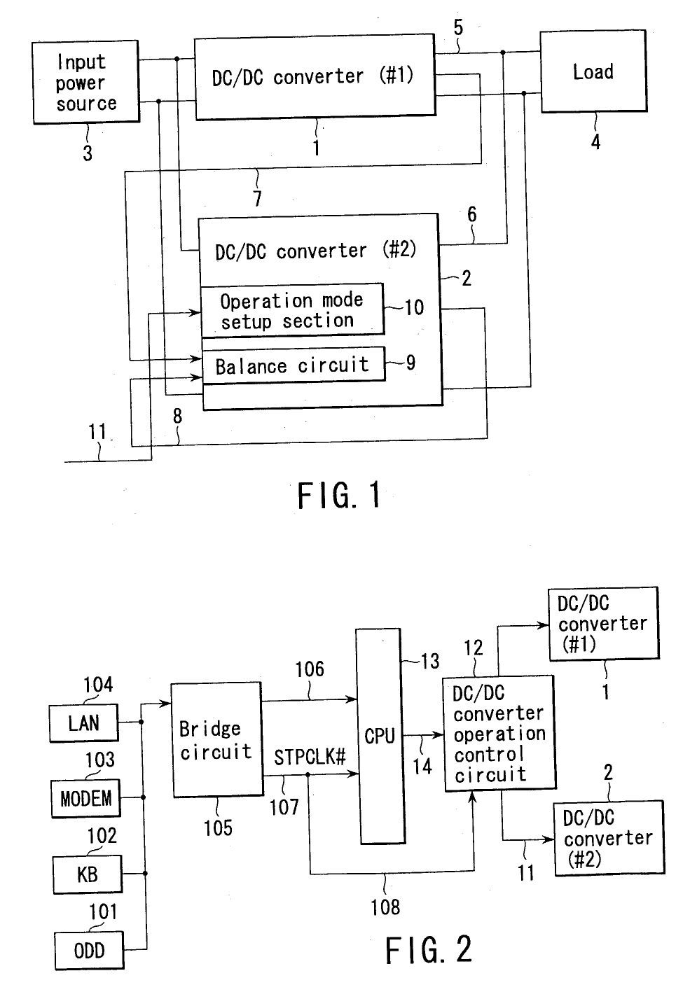

FIG. 1 is a block diagram showing the configuration of a DC/DC converter section applied to an electronic apparatus according to a first embodiment of the present invention.

As shown in FIG. 1, the electronic apparatus of the first embodiment is equipped with two DC/DC converters 1 and 2. The above two DC/DC converters 1 and 2 are interposed, and thereby, the power from an input power source 3 is effectively supplied to a load 4. The above two DC/DC converters 1 and 2 are connected in parallel and may, for example, have the same performance, and output the same power. Each of two DC/DC converters 1 and 2 is a switching regulator per se well known in the art as exemplified by U.S. Pat. No. 5,768,117 and as illustrated by the high speed Maxim Max1844 controller described in the data sheet “High-Speed Step-Down Controller with Accurate Current Limit for Notebook Computers”, both of which documents are incorporated herein by reference.

The DC/DC converter 1 is singly operable. On the other hand, the DC/DC converter 2 is used in parallel together with the DC/DC converter 1, and connected with current detection lines 7 and 8. The current detection lines 7 and 8 detect a current supplied from the DC/DC converters 1 and 2 to the load 4. The DC/DC converter 2 has a built-in balance circuit 9, which detects the output current of the DC/DC converters 1 and 2 via the current detection lines 7 and 8, and adjusts the output current so that the two currents become equal. In addition. The DC/DC converter 2 is provided with an operation mode setup section 10, which is capable of switching the start/stop operation of the DC/DC converter. The operation mode setup section 10 switches the start and stop modes of the DC/DC converter 2 in accordance with a signal supplied from the outside via a signal line 11. Namely, if the DC/DC converter 1 is used by itself, an operation stop signal is given to the operation mode setup section 10.

FIG. 2 a block diagram showing the configuration of an electronic apparatus according to the first embodiment.

In order to control the above two DC/DC converters 1 and 2, the electronic apparatus according to the first embodiment includes a DC/DC converter operation control circuit 12. A CPU 13 built in the electronic apparatus is connected to the DC/DC converter operation control circuit 12 via an operation mode determining line 14. When the operation is shifted between a normal mode for making normal power operation and a low power consumption mode of the electronic apparatus, the operation mode determining line 14 outputs a signal representing the operation mode. For example, in the normal operation, a signal “1” is outputted, and when the operation is shifted to the low power consumption mode, the above signal is switched to a signal “0”. When receiving an operation mode signal via the operation mode determining line 14, the DC/DC converter operation control circuit 12 supplies a signal for stopping the operation of the DC/DC converter 2 to the operation mode setup section 10 via the signal line 11 in the low power consumption mode. When receiving the operation stop signal, the operation mode setup section 10 stops the operation of the DC/DC converter 2.

On the other hand, if the operation is shifted from the low power consumption mode to the normal mode, the CPU 13 switches the signal outputted to the operation mode determining line 14 from “0” to “1”. When receiving the normal mode signal via the operation mode determining line 14, the DC/DC converter operation control circuit 12 supplies a signal for starting the operation of the DC/DC converter 2 to the operation mode setup section 10. When receiving the operation start signal, the operation mode setup section 10 starts the operation of the DC/Dc converter 2.

The electronic apparatus of the embodiment is provided with an Optical Disk Drive (ODD) 101, a keyboard 102, a modem 103, a LAN controller 104, and a bridge circuit 105 connected as shown in FIG. 2. The bridge circuit 105 is connected to the CPU 13.

The ODD 101 is a device for reading and writing data to the optical disk. In the ODD 101, the optical disk is rotated by motor drive, and the laser beam is irradiated to the disk surface so that data read/write can be carried out.

The keyboard 102 is an input means used as user interface.

The modem 103 is connected to the external network a via telephone line.

The LAN controller 104 is connected to a LAN network, and is used as an interface when making data exchange (transmission and reception) with apparatuses connected to the LAN network.

Each device described above outputs an interruption signal to the bridge circuit 105 when carrying out any operation. The bridge circuit 105 receives the interruption signal and feeds an interruption signal to the CPU 13 together with a signal indicating from which device the original interrupt signal originated.

Based on the interruption signal from the bridge circuit 105 and the signal indicating from which device the interrupt originated, the CPU 13 sends the control signal to the DC/DC converter operation control circuit 12 to control the operation mode of DC/DC converters 1 and 2.

For example, if the interruption signal is the interruption signal from the keyboard 102, large power is not required; therefore, the CPU 13 may be sufficiently operated in the low power consumption mode. Thus, the CPU 13 outputs a signal indicative of the low power consumption mode to the DC/DC converter operation control circuit 12.

On the other hand, if the interruption signal is the interruption signal from the ODD 101, that is, a device requiring power consumption larger than the keyboard 102, the CPU performs the following operations. When recognizing that the interruption signal is the interruption signal from the ODD 101, the CPU 13 sends the control signal to the DC/DC converter operation control circuit 12 to operate the DC/DC converters (#1) 1 and (#2) 2 in the normal mode.

As described above, the CPU 13 changes the operation mode of DC/DC converters 1 and 2 in accordance with devices generating the interruption.

The following is a description of another control example. When the CPU 13 is in the low power consumption mode, the bridge circuit 105 outputs a stop clock (STPCLK#) signal for stopping the clock frequency of the CPU 13 via a signal line 107. The stop clock signal is enabled (CPU clock stop state) when the logic is “0”, and is disabled (CPU operating state) when the logic is “1”. When the stop clock signal is enabled (signal at logic “0”), the CPU clock stops operation. In this state, if an interrupt occurs from one of the devices such as devices 101-104, the bridge circuit 105 changes the stop clock signal to the disabled state (logic “1”). Based on the mode change, the CPU 13 clock starts and thus the CPU itself starts operation. Using the function described above, a signal line 108 is connected to the DC/DC converter operation control circuit 12 from the signal line 107. By doing so, the operation of DC/DC converters 1 and 2 may be controlled in accordance with the stop clock signal STPCLK#. In this case, when the stop clock signal is enabled (logic “0”), the clock is stopped, and thereby, the CPU 13 is transferred to the low power consumption mode. Thus, the DC/DC converter operation control circuit 12 supplies a signal for stopping the operation of the DC/DC converter 2 to the operation mode setup section 10 via the signal line 11. When the stop clock signal is disabled (logic “1”), the CPU 13 operates in the normal power mode. In addition, the DC/DC converter operation control circuit 12 supplies a signal for starting the operation of the DC/DC converter 2 to the operation mode setup section 10 via the signal line 11.

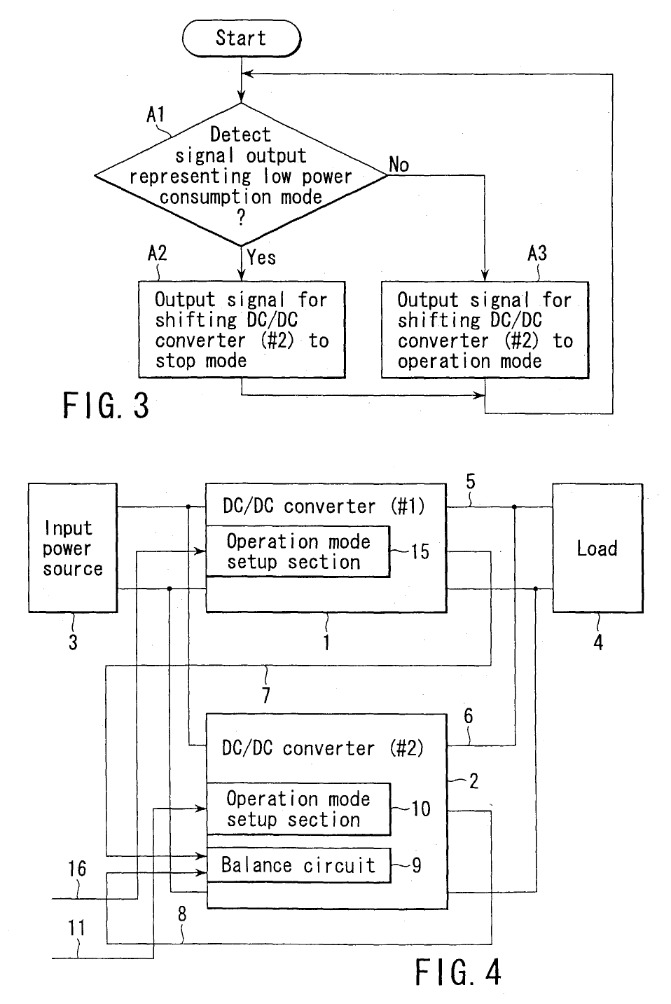

FIG. 3 is a flowchart showing a power control according to the first embodiment.

The DC/DC converter operation control circuit 12 determines whether or not the signal representing the operation mode outputted from the CPU 13 corresponds to the low power consumption mode (step A1). If the signal representing the operation mode outputted from the CPU 13 corresponds to the low power consumption mode (YES in step Al), the DC/DC converter operation control circuit 12 outputs a signal representing the “stop operation” via the signal line 11 in order to stop the operation of the DC/DC converter 2 (step A2).

On the other hand, if it is determined that the signal representing the operation mode outputted from the CPU 13 corresponds to the normal mode (NO in step Al), the DC/DC converter operation control circuit 12 outputs a signal representing the “start operation” mode via the signal line 11 in order to start the operation of the DC/DC converter 2 (step A3).

In the above first embodiment, the signal output from the CPU includes two states, namely, the normal mode or state and the low power consumption mode or state. In this case, only one signal of the above operation modes is outputted, and thereby, the operation mode may be determined.

As described above, in the first embodiment, the start/stop operation of one of the power circuits provided in parallel is switched in accordance with the operation mode of the electronic apparatus, and thereby, further power saving can be achieved in the electronic apparatus.

### Second Embodiment

FIG. 4 is a block diagram showing the configuration of a power circuit of an electronic apparatus according to a second embodiment of the present invention.

In the electronic apparatus according to the second embodiment, the DC/DC converter 1 is provided with an operation mode setup section 15 for setting the operation mode. The DC/DC converters 1 and 2 are both switching regulators, as described before. When the load becomes less than a predetermined value, power loss becomes large if the switching regulator continuously makes the switching operation. For this reason, in the electronic apparatus according to the second embodiment, the DC/DC converter 1 has the following two operation modes. That is, one is a continuous operation mode for continuously carrying out the switching operation, and another is an intermittent operation mode for intermittently carrying out the switching operation. The above two operation modes are selected in response to a signal supplied from the outside via a signal line 16.

The other configuration shown in FIG. 4 is the same as that shown in FIG. 1; therefore, explanation of same is omitted.

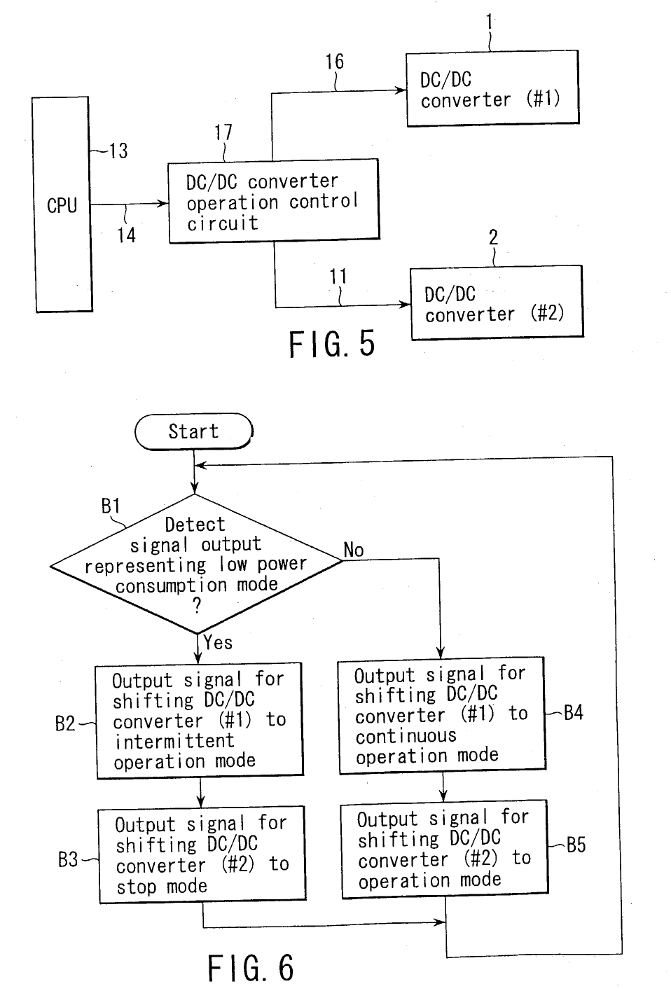

FIG. 5 is a block diagram showing the configuration of an electronic apparatus according to the second embodiment.

In the second embodiment, when detecting the shift to the low power consumption by the signal from the CPU 13, a DC/DC converter operation control circuit 17 outputs a signal representing the stop operation to the DC/DC converter 2 via the signal line 11, as in the first embodiment. The DC/DC converter operation control circuit 17 also has a function of outputting an operation mode switching signal to the DC/DC converter 1 via the signal line 16. When detecting the shift to the low power consumption by the signal from the CPU 13, the DC/DC converter operation control circuit 17 outputs a signal to the DC/DC converter 1 for switching the operation mode of the DC/DC converter 1 into the intermittent operation mode. In the DC/DC converter 1, the operation mode setup section 15 determines that the operation mode is switched, and shifts the operation mode to the intermittent mode. By doing so, the DC/DC converter 1 operates in the intermittent mode while the operation of the DC/DC converter 2 stopped.

On the other hand, if the operation mode is shifted from the low power consumption mode to the normal mode, the CPU 13 switches the signal outputted to the operation mode determining line 14 from “0” to “1”. When receiving the normal mode signal via the operation mode determining line 14, the DC/DC converter operation control circuit 17 supplies a signal for starting the operation of the DC/DC converter 2 to the operation mode setup section 10 via the signal line 11. When receiving the operation start signal, the operation mode setup section 10 starts operation of the DC/DC converter 2. The DC/DC converter operation control circuit 17 supplies a signal to the operation mode setup section 15 via the signal line 16 for setting the operation of the DC/DC converter 1 to a continuous operation mode. When receiving the continuous operation setup signal, the operation mode setup section 15 operates the DC/DC converter 1 in the continuous operation mode. In the above described embodiment, the DC/DC converter 2 is operated in a continuous mode.

FIG. 6 is a flowchart showing a power control according to the second embodiment.

The DC/DC converter operation control circuit 17 determines whether or not the signal representing the operation mode outputted from the CPU 13 corresponds to the low power consumption mode (step B1). If the signal representing the operation mode outputted from the CPU 13 corresponds to the low power consumption mode (YES in step B1), the DC/DC converter operation control circuit 17 simultaneously outputs the following signals. That is, one signal is a signal for intermittently operating the DC/DC converter 1 via the signal line 16 (step B2), and another signal is a signal for stopping the operation of the DC/DC converter 2 via the signal line 11 (step B3).

On the other hand, if it is determined in step B1 that the signal representing the operation mode outputted from the CPU 13 shows the normal mode (NO in step B1), the DC/DC converter operation control circuit 17 simultaneously outputs the following signals. That is, one signal is a signal for normally operating (i.e., a continuous mode of operation) the DC/DC converter 1 via the signal line 16 (step B4), and another is a signal for starting the operation of the DC/DC converter 2 (also operated in a continuous mode of operation) via the signal line 11 (step B5).

As described above, in the second embodiment, the start/stop operation of one of the power circuits provided in parallel is switched in accordance with the operation mode of the electronic apparatus, and the operation of the other thereof is switched into the intermittent operation. By doing so, further power saving can be achieved in the electronic apparatus.

### Third Embodiment

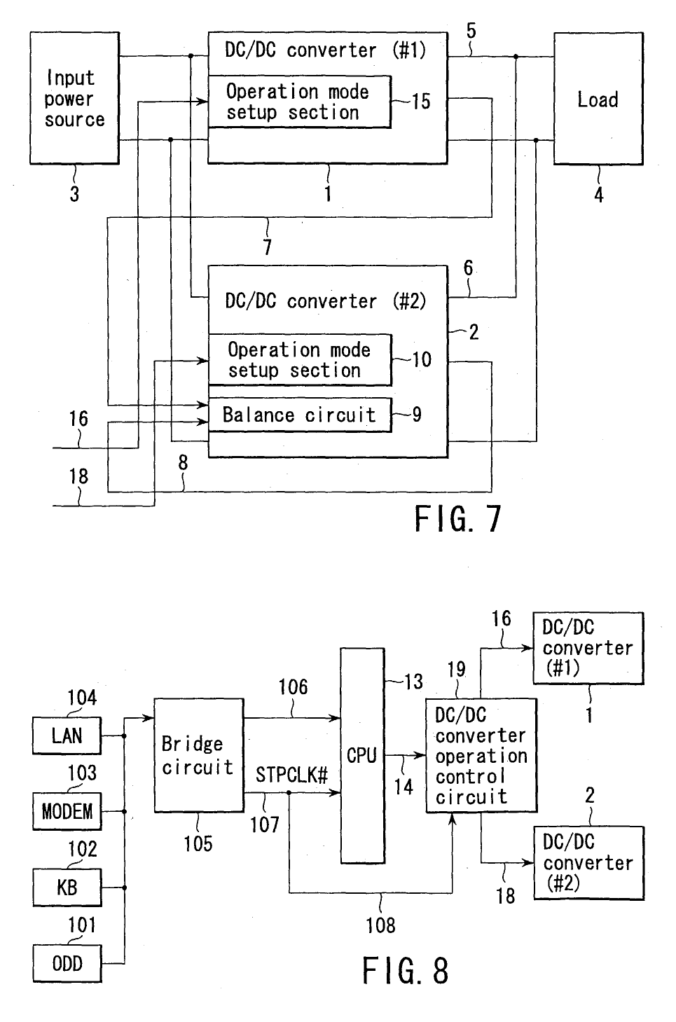

FIG. 7 is a block diagram showing the configuration of a power circuit of an electronic apparatus according to a third embodiment of the present invention.

In the electronic apparatus of the third embodiment, the DC/DC converter 2 has a continuous operation mode and an intermittent operation mode. The operation mode setup section 10 switches the above two operation modes in accordance with a signal supplied from the outside via a signal line 18. By doing so, the electronic apparatus of the third embodiment can use two DC/DC converters 1 and 2 both in the intermittent operation mode to achieve a low power consumption mode.

The other configurations of FIG. 7 are the same as that shown in FIG. 4; therefore, the explanation thereof is omitted.

FIG. 8 is a block diagram showing the configuration of an electronic apparatus according to the third embodiment.

In the third embodiment, when detecting the shift to the low power consumption by the signal from the CPU 13, a DC/DC converter operation control circuit 19 has a function of outputting an operation mode switching signal to both of the DC/DC converters 1 and 2 via signal lines 16 and 18. When detecting the shift to the low power consumption by the signal from the CPU 13, the DC/DC converter operation control circuit 19 outputs a signal for switching the operation mode of the DC/DC converter 1 into the intermittent operation and a signal to switch the operation mode of the DC/DC converter 2 to the intermittent operation mode. In the DC/DC converters 1 and 2, the operation mode setup sections 15 and 10 respectively determine that the operation mode is switched, and shifts the operation mode to the intermittent mode. By doing so, both of the DC/DC converters 1 and 2 operate in the intermittent mode.

On the other hand, if the operation mode is shifted from the low power consumption mode to the normal mode, the CPU 13 switches the signal outputted to the operation mode determining line 14 from “0” to “1”. When receiving the normal mode signal via the operation mode determining line 14, the DC/DC converter operation control circuit 19 supplies a signal for setting the operation of the DC/DC converters 1 and 2 to the continuous operation to both of the operation mode setup sections 15 and 10 via the signal lines 16 and 18. When receiving the continuous operation setup signal, the operation mode setup sections 15 and 10 operate the DC/DC converters 1 and 2 in the continuous mode, respectively.

The other configurations of FIG. 8 are the same as that shown in FIG. 2; therefore, the explanation thereof is omitted.

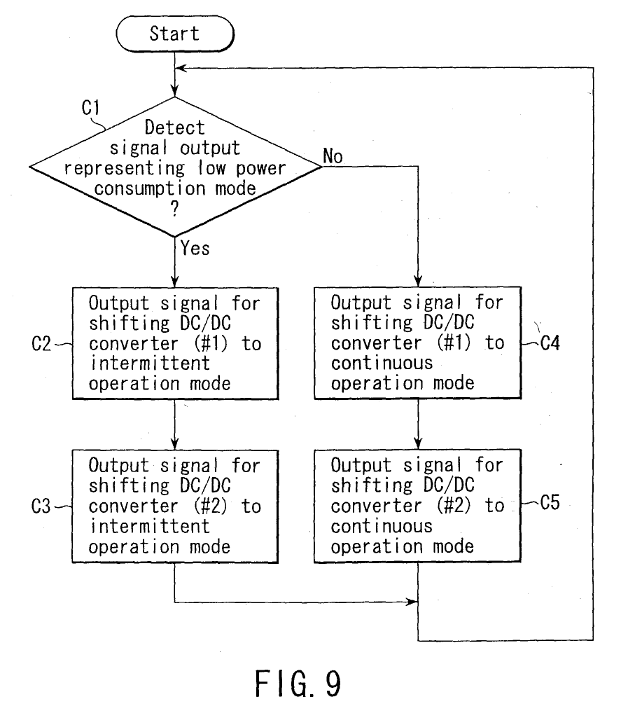

FIG. 9 is a flowchart showing a power control according to the third embodiment.

The DC/DC converter operation control circuit 19 determines whether or not the signal representing the operation mode outputted from the CPU 13 shows the low power consumption mode (step C1). If the signal representing the operation mode outputted from the CPU 13 shows the low power consumption mode (YES in step C1), the DC/DC converter operation control circuit 19 simultaneously outputs the following signals. That is, one is a signal for intermittently operating the DC/DC converter 1 via the signal line 16 (step C2), and another is a signal for intermittently operating the DC/DC converter 2 via the signal line 18 (step C3).

On the other hand, if it is determined in step Cl that the signal representing the operation mode outputted from the CPU 13 shows the normal mode (NO in step C1), the DC/DC converter operation control circuit 19 simultaneously outputs the following signals. That is, one is a signal for normally operating the DC/DC converter 1 via the signal line 16 (step C4), and another is a signal for normally operating the DC/DC converter 2 via the signal line 18 (step C5).

As described above, in the third embodiment, both power circuits provided in parallel are intermittently operated in accordance with the operation mode of the electronic apparatus. By doing so, suitable power saving can be achieved in the electronic apparatus.

In the above first to third embodiments, two DC/DC converters 1 and 2 are provided in order to simplify the explanation. The present invention is not limited to the above embodiments, even if three or more DC/DC converters are connected in parallel, the above power control method is effective.

An advantage of embodiments of the present invention will be appreciated in that the interrupt signals from the devices 101-104 and the subsequent interrupt signals from the bridge circuit 105 to the CPU 13 as discussed in connection with FIGS. 2 and 8, permits rapid power adjustment in response to computer device needs. For example, pressing a button to opening a door for inserting an optical disk into the ODD 101 immediately generates an interrupt signal to very quickly cause additional power to be generated by, for example, changing the operating mode from a low power mode to a high power mode.

It will also be appreciated that while the above described embodiments utilized a normal and low power range, the DC/DC converters 1 and 2 could operate in a larger number of different power ranges. For example, in the third embodiment, the normal power range is achieved by having both DC/DC converters 1 and 2 operate in a continuous mode, and a low power range is achieved by having both converters operate in an intermittent mode. It is also possible to have converter 1 operate in an intermittent mode and converter 2 operate in a continuous mode to yield a total of three separate power levels. Providing an “off” state as in the first embodiment would provide even further choices in power levels. In such cases, the power requirements of the CPU could be matched more precisely to various different power outputs of the DC/DC converters. In such cases, the signals from the CPU 13 to the DC/DC converter operation control circuit 19 (FIGS. 2 and 8) would consist of plural bit lines and simple decoders may be employed in the control circuits 12 and 19 to decode the desired power level between continuous, intermittent and on/off states.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus operable in a first mode operating at a first power and a second mode operating at a second power smaller than the first power, comprising:
a first power supply unit configured to supply power to the electronic apparatus when the electronic apparatus operates in the first or second mode; and
a second power supply unit configured to supply power to the electronic apparatus in the first mode, and reduce or stop the power supply to the electronic apparatus in the second mode.

2. An electronic apparatus operable in a first mode operating at a first power and a second mode operating at a second power smaller than the first power, comprising:
a first power supply unit configured to supply power to the electronic apparatus;
a second power supply unit configured to supply power to the electronic apparatus; and
a control unit configured to reduce or stop an operation of the second power supply unit when the electronic apparatus shifts from the first mode to the second mode.

3. The electronic apparatus according to claim 2, wherein the control unit includes a restarting unit configured to restart the stopped operation of the second power supply unit when the electronic apparatus returns from the second mode to the first mode.

4. The electronic apparatus according to claim 2, wherein the control unit shifts the operation of the first power supply unit from a continuous power supply mode to an intermittent power supply mode when the electronic apparatus shifts from the first mode to the second mode.

5. The electronic apparatus according to claim 4, wherein the control unit returns the operation of the first power supply unit from the intermittent power supply mode to the continuous power supply mode when the electronic apparatus returns from the second mode to the first mode.

6. The electronic apparatus according to claim 2, wherein the control unit monitors whether or not a signal representing the second mode is outputted from a CPU, and thereby, shifts between the first and second modes.

7. An electronic apparatus operable in a first mode operating at a first power and a second mode operating at a second power smaller than the first power, comprising:
a first power supply unit configured to supply power to devices included in the electronic apparatus;
a second power supply unit configured to supply power to devices included in the electronic apparatus; and
a control unit configured to operate the first and second power supply unit when the electronic apparatus operates in the first mode, and reduce or stop the operation of the second power supply unit when the electronic apparatus operates in the second mode.

8. The electronic apparatus according to claim 7, wherein the first and second power supply unit are DC/DC converters.

9. The electronic apparatus according to claim 7, wherein the control unit shifts the operation of the first power supply unit from a continuous power supply mode to an intermittent power supply mode when the electronic apparatus shifts from the first mode to the second mode.

10. The electronic apparatus according to claim 9, wherein the control unit returns the operation of the first power supply unit from the intermittent power supply mode to the continuous power supply mode when the electronic apparatus returns from the second mode to the first mode.

11. The electronic apparatus according to claim 7, wherein the control unit monitors whether or not a signal representing the second mode is outputted from a CPU, and thereby, shifts between the first and second modes.

12. An electronic apparatus operable in a first mode operating at a first power and a second mode operating at a second power smaller than the first power, comprising:
at least two power supply units; and
a control unit configured to shift the operation of the at least two power supply units from a continuous power supply mode to an intermittent power supply mode when the electronic apparatus shifts from the first mode to the second mode.

13. The electronic apparatus according to claim 12, wherein the control unit returns the operation of the at least two power supply units from the intermittent power supply mode to the continuous power supply mode when the electronic apparatus returns from the second mode to the first mode.

14. The electronic apparatus according to claim 12, wherein the control unit monitors whether or not a signal representing the second mode is outputted from a CPU, and thereby, shifts between the first and second modes.

15. A power control method of an electronic apparatus including first and second power supply units and operable in a first mode operating at a first power and a second mode operating at a second power smaller than the first power, comprising:
stopping the operation of the second power supply unit when the electronic apparatus shifts from the first mode to the second mode.

16. The power control method according to claim 15, further comprising:
restarting the stopped operation of the second power supply unit when the electronic apparatus returns from the second mode to the first mode.

17. The power control method according to claim 15, further comprising:
shifting the operation of the first power supply unit from a continuous power supply mode to an intermittent power supply mode when the electronic apparatus shifts from the first mode to the second mode.

18. The power control method according to claim 17, further comprising:
returning the operation of the first power supply unit from the intermittent power supply mode to the continuous power supply mode when the electronic apparatus returns from the second mode to the first mode.

19. A power control method of an electronic apparatus including at least two or more power supply units and operable in a first mode operating at a first power and a second mode operating at a second power smaller than the first power, comprising:
shifting the operation of the power supply units from a continuous power supply mode to an intermittent power supply mode when the electronic apparatus shifts from the first mode to the second mode.

20. The power control method according to claim 19, further comprising:
returning the operation of the power supply units from the intermittent power supply mode to the continuous power supply mode when the electronic apparatus returns from the second mode to the first mode.

21. A portable computer having a plurality operating devices each having an active and inactive state, said portable computer operating in at least a first, second and third operating state, said first operating state utilizing a first power level, said second operating state utilizing a second power level smaller than said first operating level, and said third operating state utilizing a third power level smaller than said second power level, said portable computer comprising:
a) a CPU;
b) a power supply circuit for supplying power, at one of said first, second and third power levels, to said CPU said plurality of operating devices;
c) a control unit for operating said power supply circuit at one of said second or third power levels and, in response to a power mode signal from said CPU, for operating said power supply circuit at said first power level, and
d) wherein actuation of ones of said plurality of operating devices to said active state generates an interrupt signal to said CPU, and in response thereto, said CPU generates said mode signal.
